(19) United States
(12) Patent Application Publication
(10) Pub. No.: US 2026/0013652 A1
(43) Pub. Date: Jan. 15, 2026

(54) SWING SEAT SUITABLE FOR CHILDREN THAT REQUIRE ADDITIONAL SUPPORT

(71) Applicant: PlayCore Wisconsin, Inc., Chattanooga, TN (US)

(72) Inventors: Anthony Parker, Fort Payne, AL (US); Lloyd W. Reese, Farmington, MO (US); Thomas Robert Norquist, Fort Payne, AL (US)

(21) Appl. No.: 18/768,223

(22) Filed: Jul. 10, 2024

(51) Int. Cl. A47D 15/00; A63G 9/02

(52) U.S. Cl. CPC A47D 15/006; A63G 9/02

(57) ABSTRACT

An improved swing seat for use by children with disabilities includes first and second rotating arms, which are configured to rotate about a substantially vertical axis between an open position in which a user can exit the seat in a forward direction and a closed position in which the first and second rotating arms prevent a user from exiting the seat in a forward direction. The rotating arms may each include a latch element which may be fastened together in a manner similar to a conventional automobile seat belt. The swing seat may also have a variety of other features which represent improvements over conventional swing seats of this sort.

### BACKGROUND

Swing seats that are configured for use by children that require additional support, e.g. those with physical disabilities, are common at public playgrounds. These swing seats generally have a rigid “Y”-shaped harness that rotates downward, i.e. about a horizontal axis, over the top of an occupant and which latches into either the base of the seat or a component extending upward from the base. While these seats work for their intended purpose, after decades of experience and study, the present inventors have identified a number of drawbacks with the current seat designs. For instance, if the rigid “Y”-shaped harness is not securely latched in the closed position during use, it can extend forward (or in some instances rearward) of the seat, which can pose a safety hazard to other children or adults that might walk into the swing path of the seat. Further, latching of the harness at the base of the seat can be difficult, which can either lead to the latch not being adequately secured (and thus the swing seat being inadvertently operated without the protection provided by the harness) and/or the latch pinching an occupant's legs during the step of securing it.

### SUMMARY OF THE INVENTION

The present disclosure is directed to an improved swing seat that can be installed in a public recreational space, such as a park, playground, etc., and which is configured for use by children with disabilities. The swing seat includes a rigid seat, which may be molded of a rigid, e.g. plastic, material, having at least a bottom support and a back support and a pair of (first and second) rotating arms that are configured to rotate about a substantially vertical axis between an open position in which a user can exit the seat in a forward direction, and a closed position in which the rotating arms prevent a user from exiting the seat in a forward direction. Each of the first and second rotating arms may extend frontward from the back support of the seat and rotate outward (away from the horizontal center of the seat, toward and optionally beyond the side edges of the seat) to the open position and inward (toward the horizontal center of the seat) to the closed position. The swing seat also includes a latch configured to secure the rotating arms in the closed position and a plurality of mounting elements by which the rigid seat can be suspended from an overhead support bar.

Each of the rotating arms may be made, e.g. molded, of a rigid material, e.g. a rigid plastic, and may be rotatably mounted to an axle that extends (substantially vertically) through a portion of the rigid seat. Each of the rotating arms may be curved downward so as to extend over a seat occupant's shoulders and down to a midsection of the seat occupant.

Each of the first and second rotating arms may include a first end that is rotatably mounted to the back support. For instance, the back support may include a lower portion, e.g. configured to support the back of an occupant, and an upper portion, e.g. configured to support the head of an occupant, and the first end of each of the rotating arms may be rotatably mounted at a side of the upper portion. Each of the first and second rotating arms may also include a second end that includes a latch element. For instance, the latch may include a first latch element and a second latch element, with the first latch element being positioned at the second end of the first rotating arm and the second latch element being positioned at the second end of the second rotating arm. During operation, the second end of each of the rotating arms may be positioned directly in front of the back support when in the closed position and at (or beyond) the sides of the back support when in the open position.

The first and second latch elements may be fastened together to hold the rotating arms in the closed position and unfastened to allow the arms to move to the open position. In some embodiments, rotation of each of the first and second arms from the closed position to the open position may be controlled by one or more springs, e.g. such that when the latch elements are unfastened the rotating arms will naturally and controllably move to the open position. In some embodiments, one of the first and second latch elements may be a male element and the other of the first and second latch elements may be a female element. The male and female elements may operate as a buckle, e.g. akin to a conventional seat-belt buckle from an auto vehicle, to secure the rotating arms in the closed position. The buckle may also comprise a button that, when activated, releases the male element from the female element. In some embodiments, at least one of the rotating arms, and desirably the rotating arm that includes the male latch element, may have a protective portion that extends behind the male latch element to protect an occupant of the seat from being pinched when the latch elements are fastened together.

In some embodiments, the rigid seat may further include one or more side restraints, e.g. for lumbar support, positioned on each side of the bottom and/or back support. The side restraints may be integral with the bottom and/or back support. In some embodiments, for instance, the rigid seat may be an integral molded component. In some embodiments, the profile of the rigid seat may be configured for improved comfort and safety. For instance, a transition between the bottom support and the back support may be rounded to provide a contoured seating surface which may also provide the rear of the seat with improved impact absorption. The bottom support of the rigid seat may include a saddlehorn projection in the front that reduces or prevents an occupant from sliding along the surface of the bottom support during operation of the swing seat.

In some embodiments, the swing seat may also include a cushioning bumper affixed to the leading edge of the bottom of the rigid seat. The cushioning bumper may be made of any low durometer material (relative to the rigid material of the swing seat), such as rubber. To further improve the cushioning effect, the bumper may also be hollow. In contrast with conventional rubber bumpers, the bumper of the present swing seat may extend across the entire side-to-side width of the rigid seat, thereby reducing the risk of injury if a child or adult were to be impacted by the swing seat, regardless of whether the impact occurred directly by the front of the seat or less directly by the front edges of the seat.

In some embodiments, the seat may be configured such that access to the mounting elements is improved. For instance, each of the mounting elements, e.g. shackles for receiving an end of a chain by which the swing seat is suspended from an overhead support structure, may be exterior to the rigid seat. In conventional swing seats configured for use by children with disabilities, the mounting elements are typically interior to the rigid, e.g. plastic, seat, which can lead to wear in a non-visible area and eventual failure due to undiagnosed wear. By placing the mounting elements on the exterior of the rigid seat, any such wear could be seen and diagnosed prior to failure.

In some embodiments, at least two of the plurality of mounting elements may be secured to the rigid seat by rods. The rods may serve multiple purposes. In some embodiments, the rods that attach an upper two of the plurality of mounting elements to the rigid seat may also serve as axles for the first and second rotating arms. In some embodiments, the rods that attach a lower two of the plurality of mounting elements to the rigid seat may also serve to secure the cushioning bumper to the rigid seat.

The swing seat may further include a plurality of chains, each chain being affixed (a) to at least one of the plurality of mounting elements and (b) to an overhead support bar, such that the swing seat is suspended from the overhead support bar and operable to move in a to and fro swinging motion. The plurality of chains may include (or consist of) a pair of front chains attached to a pair of lower mounting elements and a pair of rear chains attached to a pair of upper mounting elements. In some embodiments, the swing seat may be configured such that the first and second rotating arms do not extend forward of the front chains in either the open or closed position or when moving between the open and closed position. This is an improvement over conventional swing seats of this type, in which the Y-shaped yoke can extend forward of the seat, thereby posing a safety hazard to other children or adults that might walk into the swing path of the seat.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1 is a front perspective view of an embodiment of a swing seat in accordance with the present disclosure, showing the rotating arms in an open position.

FIG. 2 is a front elevation view of the embodiment illustrated in FIG. 1, showing the rotating arms in an open position.

FIG. 3 is a front perspective view of the embodiment illustrated in FIG. 1, showing the rotating arms in a closed position.

FIG. 4 is a front elevation view of the embodiment illustrated in FIG. 1, showing the rotating arms in an open position.

FIG. 5 is a side elevation view of the embodiment illustrated in FIG. 1.

FIG. 6 is a rear elevation view of the embodiment illustrated in FIG. 1.

### DETAILED DESCRIPTION OF THE INVENTION

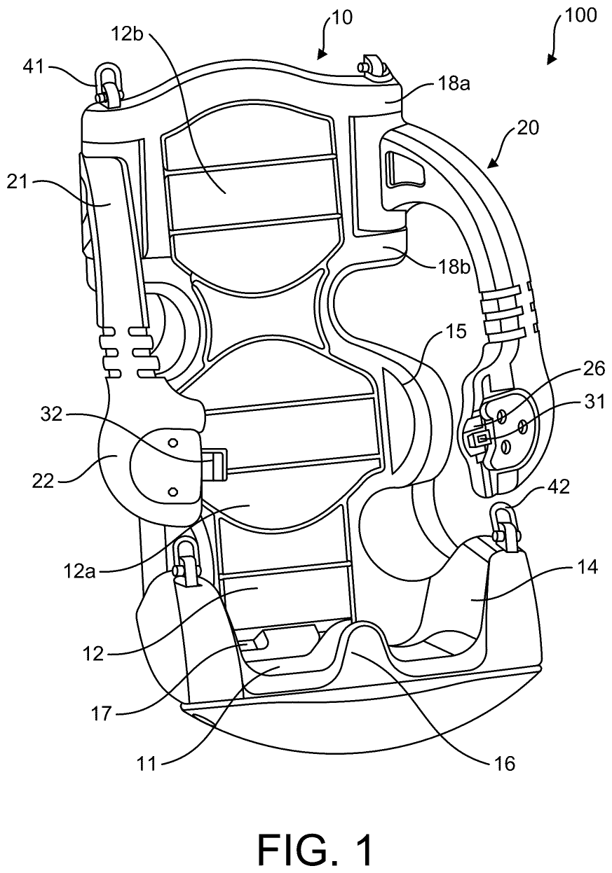

An embodiment of a swing seat 100 in accordance with the present disclosure is shown in FIGS. 1-6.

The swing seat 100 comprises a rigid seat element 10 that has at least a bottom support 11 and a back support 12. The bottom support 11 is configured for a child user to sit on and the back support 12 is configured to support the child user in a substantially upright sitting position. The back support may be made up of a lower portion 12a that is configured to support the back of a child occupant during use and an upper portion 12b that is configured to support the head of a child occupant during use. In some embodiments, the lower portion 12a and the upper portion 12b may be integral with one another as shown in the illustrated embodiment.

The rigid seat element 10 may also comprise one or more side supports. In the illustrated embodiment, for instance, the rigid seat element 10 comprises a first set of side supports 14 extending upward on each side of the bottom support 11 and a second set of side supports 15 extending forward from each side of the back support 12 (and more specifically from each side of the lower portion of the back support). Each of the side supports 14, 15 serve to help to limit side-to-side movement of a child occupant of the rigid seat element 10. Side supports 15 may also be configured to provide a child occupant with a degree of lumbar support.

The bottom support 11 may further include a saddlehorn element 16 extending upward from the top surface and which is configured to be positioned between a child occupant's legs to thereby further restrict movement of the child during operation of the swing seat 100. The bottom support 11 may also include one or more drainage apertures 17 that allow rainwater to drain off of the rigid seat element 10. In the illustrated embodiment, drainage apertures 17 are positioned at the transition between the bottom support 11 and the back support 12. The top surface of the bottom support 11 also declines (slopes downward) toward the rear, such that water landing on the top surface of the bottom support will flow rearward toward the one or more drainage apertures 17. The sloping of the bottom support 11 in this manner may also help maintain a child occupant in a desirable sitting position.

The upper portion 12b of the back support 12 may include upper and lower extension elements 18a, 18b on each side. The upper and lower extension elements 18a, 18b on each side of the upper portion 12b of the back support 12 define a space that is configured to receive an end of one of the rotating arms. The upper and lower extension elements 18a, 18b may each have an aperture running vertically through the element and configured to receive an axle on which the rotating arm rotates.

As shown in the illustrated embodiment, the rigid seat element 10 may have a curved transition 19 between the bottom support 11 and the back support 12. This may provide a comfortably contoured seating surface. Moreover, by rounding off the rear surface of the rigid seat element 10 to create a sort of “egg” shape, the rigid seat may be provided with improved impact absorption.

The rigid seat element 10 may be made from any of a variety of rigid materials. In many embodiments, the rigid seat element is molded from a rigid plastic material, such as those commonly used in playground equipment and, in particular, adaptive swing seats. In some embodiments, including that illustrated in FIGS. 1-6, the rigid seat element 10 may be a single integral unit, e.g. a molded plastic unit. In other, non-illustrated embodiments, one or more components may be affixed together to form the rigid seat element 10.

The swing seat 100 also comprises first and second rotating arms 20. Each of the rotating arms comprises a first end 21 that is rotatably mounted to the rigid seat 10, and more specifically to the back support 12 of the rigid seat (and even more specifically the upper portion 12b of the back support of the rigid seat). Each rotating arm 20 may be rotatably attached to a side of the back support 12, and more specifically a side of the upper portion 12b of the back support such that the first end 21 of each rotating arm is positioned to the side of the upper portion of the back support. As shown in the illustrated embodiment, the first end 21 of each rotating arm may be received between the upper and lower extension elements 18a, 18b. An axle 23 may extend through the upper extension element 18a, an aperture in the first end 21 of the rotating arm 20, and the lower extension element 18b, respectively. The rotating arm 20 may rotate upon the axle 23.

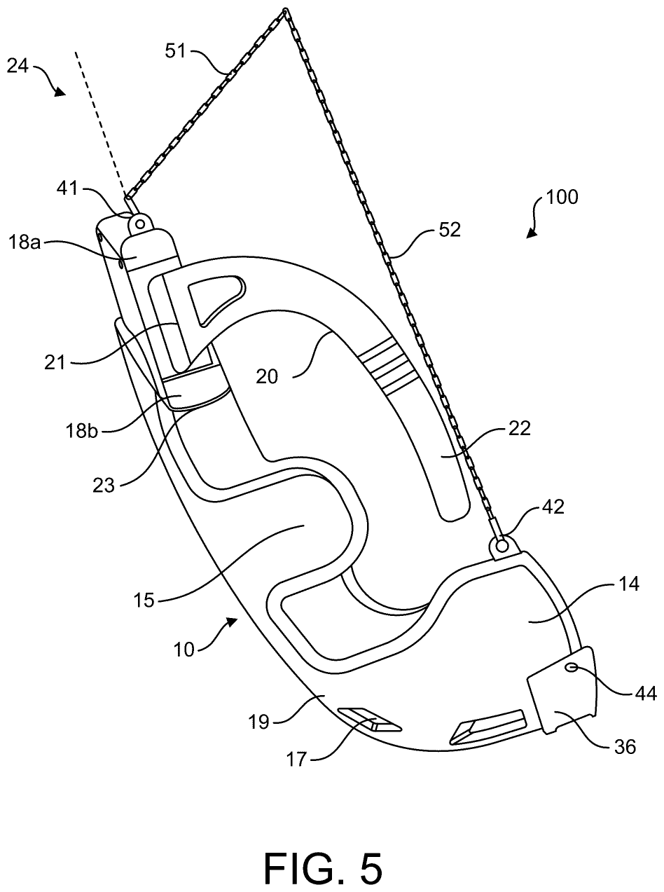

The axle 23, and thus the axis of rotation 24 for the rotatable arms 20, may extend substantially vertically when the swing seat 100 is suspended from an overhead support structure and in a rest position. As can be seen in FIG. 5, the back support 12 of the rigid seat 10 may be inclined rearward to provide a desired seating position, in which case the axis of rotation 24 for the rotatable arms 20 may not be vertical but rather may form an angle of about 30° or less from vertical, alternatively about 25° or less from vertical, alternatively about 20° or less from vertical, alternatively about 15° or less from vertical, alternatively about 10° or less from vertical, alternatively about 5° or less from vertical, all of which are considered substantially vertical for purposes of the present disclosure. This is in stark contrast to conventional adaptive swing seats in which a Y-shaped yoke rotates about a substantially-horizontal axis of rotation.

Each of the first and second rotating arms 20 extends frontward from the back support 12. Each rotating arm 20 may comprise a main body that extends forward and downward from the first end 21. Each of the rotating arms also comprises a second end 22 that is a free end. Between the first end 21 and the second end 22, the main body of each rotating arm 20 may curve downward so as to extend over a seat occupant's shoulders and down to a midsection of the seat occupant.

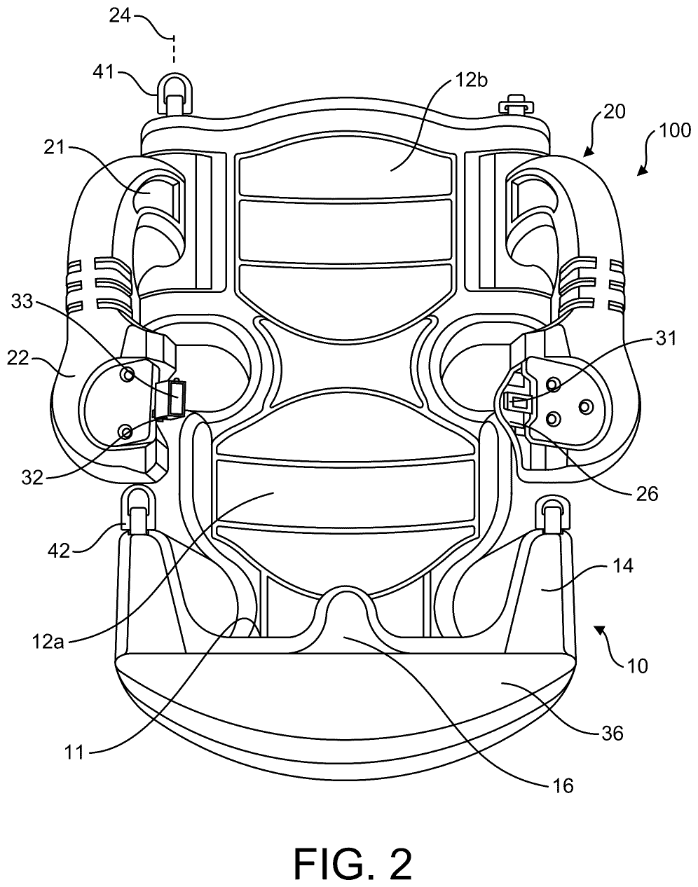

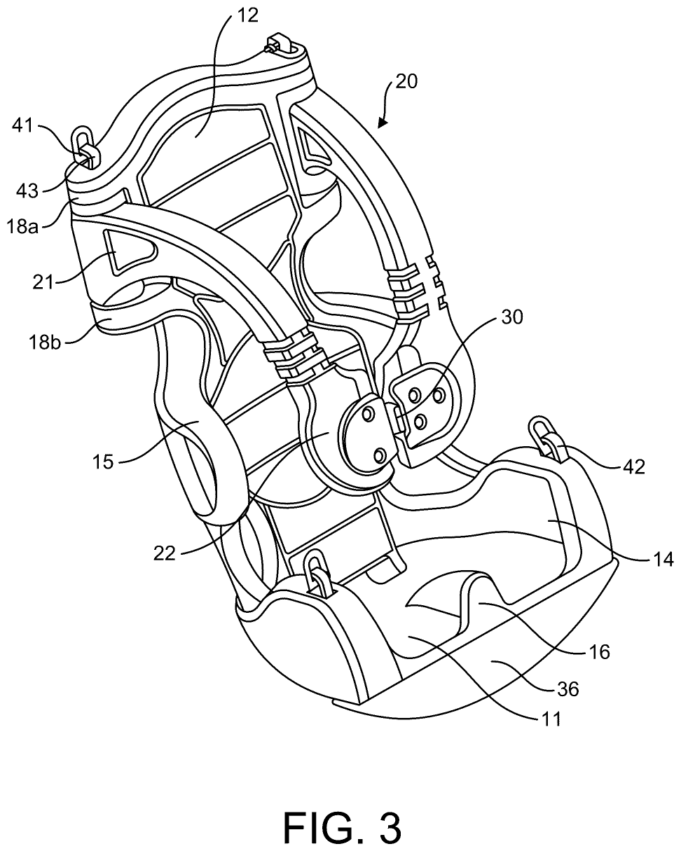

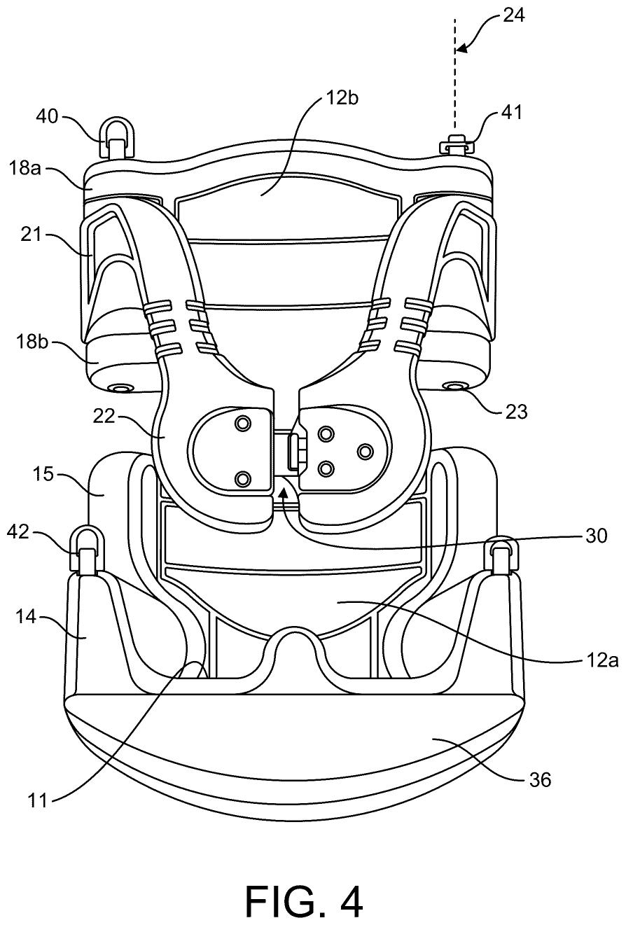

The rotating arms 20 are configured to move between an open position, e.g. as shown in FIGS. 1-2, and a closed position, e.g. as shown in FIGS. 3-4. In the open position, each of the rotating arms 20, including the second end 22 of each of the rotating arms, may be positioned along the sides of the back support 12 of the rigid seat element 10, e.g. as seen in FIG. 2. In the closed position, each of the rotating arms 20 may be positioned such that the second end 22 of each arm is positioned directly in front of the back support 12 of the rigid seat element 10, e.g. as seen in FIG. 4.

Rotation of each of the rotating arms 20 between the open and closed position may be limited by one or more internal stops that may be built into the arm connection. The internal stops may prevent the rotating arms 20, and more particularly the second ends 22 of the rotating arms from contacting one another when in the closed position; may prevent the rotating arms from extending too far from the rigid seat element 10 (e.g. in a forward, side, or rearward direction) when in the open position; or desirably both. By preventing the second ends 22 of the rotating arms 20 from contacting one another when in the closed position, the chances of pinching of an occupant may be significantly reduced. By preventing the rotating arms 20 from extending too far from the rigid seat element 10 when in the open position, the chances of a bystander being struck by the rotating arms, rather than a cushioned portion of the swing seat 100, may be significantly reduced.

The second end 22 of each rotating arm may comprise a latch element. In some embodiments, including the illustrated embodiment, the second end 22 of one of the rotating arms 20 comprises a male latch element 31 and the second end of the other one of the rotating arms comprises a female latch element 32. The male latch element 31 may be received by the female latch element 32 in order to fasten the two latch elements together. Together, the two latch elements 31, 32 form a latch 30 that is configured to secure the first and second rotating arms 20 in the closed position. The latch 30 also comprises an actuator, e.g. a button 33, which when pressed will release the male latch element 31 from the female latch element 32, thereby unsecuring the rotatable arms 20 and allowing the arms to rotate to the open position. As seen in the illustrated embodiment, the button 33 may be positioned on a portion of the female latch element 32 in the same manner as an automobile seatbelt latch. By providing a latch 30 that operates in such a familiar manner, the ease of operation will be improved.

In some embodiments, a portion 26 of at least one of the rotatable arms 20 may extend behind the latch 30, or at least a portion of the latch, when the latch elements 31, 32 are fastened together. This will reduces the chance of any portion of the child occupant from being pinched when the latch elements 31, 32 are fastened together. In the illustrated embodiment, a portion 26 of the rotatable arms 20 extends behind the male latch element 31, as shown for example in FIG. 2. Although a seatbelt-style latch 30 is shown and described herein, alternative latch configurations are contemplated without departing from the scope of the invention.

In some embodiments, movement of the rotatable arms 20 from the closed position to the open position may be controlled by one or more springs 34, e.g. one or more torsion springs. When present, the one or more springs 34 form part of the operable connection between each rotatable arm 20 and the axle 23 on which it rotates and is desirable wholly concealed within an interior of the swing seat 100. The one or more springs 34 may be configured so that when the latch 30 is unfastened, the rotatable arms 20 automatically, but controllably (i.e. slowly), move toward the open position. Because the rotatable arms 20 are biased by the spring 34 to the open position, a degree of force may be needed to rotate the arms from the open position to the closed position. Unless and until the rotatable arms 20 are latched together, the one or more springs 34 may bias the arms into an open position.

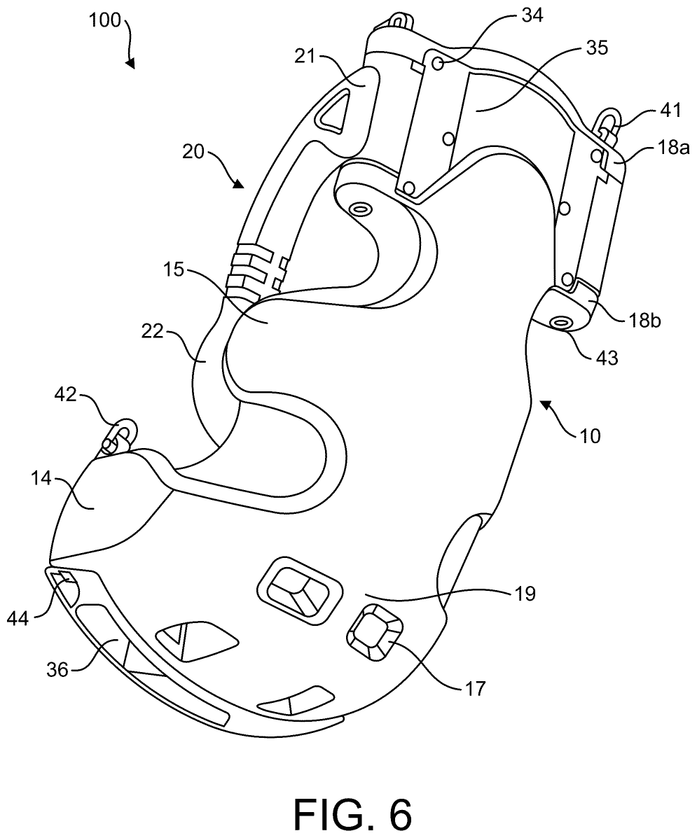

In some embodiments, one or more plates 35 may be attached to the rear of the rigid seat element 10 in the area adjacent to the upper and lower extension elements 18a, 18b. As can be seen in FIG. 6, for example, the illustrated embodiment includes a plate 35 that extends across a portion of the rear of the back support 12 between the first ends 21 of the rotatable arms. These one or more plates 35 may be configured to prevent a child or adult's fingers from being pinched during rotation of the rotatable arms 20. The one or more plates 35 may be made of a rigid material such as metal, plastic, or the like.

Embodiments of the swing seat 100 may further include a cushioning bumper 36 affixed to the bottom support 11. The cushioning bumper 36 may extend along the leading front edge of the rigid seat element 10, thereby dampening any impact of the front of the rigid seat element on any person or object that should enter into the swing path of the swing seat 100. The cushioning bumper 36 desirably spans the entire width of the leading front edge of the rigid seat element 10, thereby providing a dampening effect regardless of whether the impact is direct or more glancing.

The swing seat 100 also comprises a plurality of mounting elements 40 by which the rigid seat element 10 can be suspended, via chains or the like, from an overhead support. As shown in the illustrated embodiment, these mounting elements 40 may generally take the form of shackles, though the exact design of the shackles may vary from what is shown in the illustrated embodiment. In some embodiments, at least one, and desirably all, of the mounting elements 40 may be exterior to the rigid seat element 10. This improves upon the mounting elements of conventional adaptive swing seats, which are concealed within the swing seat and thus subject to undiagnosed wear and eventual failure. In the illustrated embodiment, all of the mounting elements 40 are positioned on the exterior of the rigid seat element 10. By the mounting element 40 being positioned on the exterior of the rigid seat element 10, it is understood that some portion of the mounting element may extend into the rigid seat element in order to secure it in place, so long as the element to which a chain or the like attaches to suspend the swing seat 100 is on the exterior of the rigid seat element.

In some embodiments, the plurality of mounting elements 40 may comprise a pair of upper mounting elements 41 (which can also be referred to as rear mounting elements) and a pair of lower mounting elements 42 (which can also be referred to as front mounting elements). The upper mounting elements 41 may be positioned at the top of the back support 12, with for instance one being at each side of the back support as shown in the illustrated embodiment. The lower mounting elements 42 may be positioned along the sides of the bottom support 11, e.g. at the top of each side support 14 as shown in the illustrated embodiment. Together, the set of upper mounting elements 41 and lower mounting elements 42 provide mounting points for chains that, when the swing seat 100 is suspended from an overhead support, provides the swing seat with sufficient side-to-side and front-to-back stability throughout the intended to and fro swinging motion.

The mounting elements 40 may be affixed to the rigid seat element 10 in any of a variety of manners, as would generally be understood by a person of skill in the art. In some embodiments, however, the upper mounting elements 41, the lower mounting elements 42, or both may be affixed to the rigid seat element 10 by multi-purpose rods.

In some embodiments, for instance, each upper mounting element 41 may be affixed to the rigid seat 10 by a rod 43 that also operates as the axle 23 for one of the rotating arms 20. As shown in the illustrated embodiment, for instance, the rod 43 may extend through a portion of the upper mounting element 41, through the upper extension element 18a, through the first end 21 of one of the rotating arms 20, and through the lower extension element 18b. Note that the elements through which the rod 43 extends has been described moving from top to bottom, that does not mean that the rod (e.g. bolt) must actually be inserted in that direction and it should be understood that the rod (e.g. bolt) may also be inserted in the opposite direction and may, for example, screw into internal threading within a portion of the mounting element 41, be secured in place with a nut, or the like.

In some embodiments, each lower mounting element 42 may be affixed to the rigid seat 10 by a rod 44 that also operates to affix the cushioning bumper 36 to the bottom support 11 of the rigid seat 10. As shown in the illustrated embodiment, for instance, the rod 44 may extend through a portion of the lower mounting element 42, through the side support 41 positioned at the side of the bottom support 11 and through the bumper 36, thereby affixing both the lower mounting element and the bumper to the rigid seat element 10. As above, though the elements through which the rod 44 extends has been described moving from top to bottom, that does not mean that the rod (e.g. bolt) must actually be inserted in that direction and it should be understood that the rod (e.g. bolt) may also be inserted in the opposite direction and may, for example, screw into internal threading within a portion of the mounting element 42, be secured in place with a nut, or the like.

When installed, the swing seat 100 further comprises chains (or cables, etc.) 50 that are attached to both the plurality of mounting elements 40 and an overhead support beam, e.g. through conventional swing hangers, such that the swing seat is suspended from the overhead support beam and is operable to move in a to and fro swinging motion. Those chains 50 may include a pair of rear chains 51, each of which is attached to one of the upper mounting elements 41 and a pair of front chains 52, each of which is attached to one of the lower mounting elements 42. Generally, each of the chains 50 will have a first end attached to one of the mounting elements 40 and a second end attached to the overhead support beam (either directly or indirectly through connection to another chain). In some embodiments, however, one chain 50 may operate as both one of the rear chains 51 and one of the front chains 52, e.g. by having a first end attached to one of the upper mounting elements 41, a second end attached to one of the lower mounting elements 42, and a section along its length being attached to the overhead support beam (either directly or indirectly through connection to another chain).

In some embodiments, additional chains or bars may link one or more of the chains one side of the swing seat 100 to one or more of the chains on the other side of the swing seat, thereby providing a suspension assembly that provides the swing seat 100 with even greater stability. For example, a stability-improving crossbar or cross-chain may link together the two rear chains 51, thereby further reducing side-to-side movement of the swing seat 100.

In alternative, non-illustrated, embodiments, a different suspension assembly may be utilized. This may involve a different arrangement of chains 50 or even a different arrangement of mounting elements 40. In some embodiments, for instance, the swing seat 100 may include a single upper mounting element 41 positioned at the top of the back support 12 at or near its center rather than a pair in which one is positioned at each side of the back support. A chain 50 attached to that single upper mounting element 41 may extend upward and then branch out upward to each side (with each branch attaching to the overhead support, e.g. through a conventional swing hanger), forming a “Y” shape, to provide the swing seat 100 with a desired degree of side-to-side and front-to-back stability.

The swing seat 100 is configured to provide a conventional to-and-fro playground swinging motion. However, by replacing the conventional harness used on current adaptive swing seats with the rotatable arm 20 assembly described herein, swing seats 100 of the present disclosure provide improved safety, both for users and bystanders, and improved comfort. Notably, even if the rotatable arms 20 of embodiments of the present swing seat 100 are in the open position while the swing seat is in motion, no part of those arms extends forward of the front of the rigid seat element 10 (or rearward of the rear of the rigid seat element). Indeed, in some embodiments, no part of the rotatable arms 20 of embodiments of the present swing seat 100 extends forward of the front chains 52 (or rearward of the rear chains 51), regardless of whether the rotatable arms are in the open or closed position. Accordingly, there is little to no chance of a person that enters the swing path of the present swing seat 100 being impacted by the rotatable arms; rather such a person would be impacted by either the cushioning bumper 36 or the rounded rear 19 of the rigid seat element, both of which are designed to better absorb such an impact, thereby reducing the risk of injury.

Further, by providing an improved latching system that does not latch in between a child's legs in the manner of current adaptive swing seats, the risk of pinching for an occupant when being secured in the swing seat 100 is greatly reduced. The ease of operation of the latching system of the present swing seat 100 (along with biasing of the rotatable arms 20 in the open position) also reduces the chances of inadvertent operation of the swing with the front restraint not securely fastened.

It can be seen that the described embodiments provide a unique and novel swing seat 100 that have a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A swing seat configured for use by children with disabilities, the swing seat comprising:
a rigid seat having at least a bottom support and a back support;
a plurality of mounting elements by which the rigid seat can be suspended from an overhead support bar;
first and second rotating arms, each of the first and second rotating arms being configured to rotate about a substantially vertical axis between an open position in which a user can exit the seat in a forward direction, and a closed position in which the first and second rotating arms prevent a user from exiting the seat in a forward direction; and
a latch configured to secure the first and second rotating arms in the closed position.

2. The swing seat of claim 1, wherein the first and second rotating arms extend frontward from the back support of the seat and rotate outward to the open position and inward to the closed position.

3. The swing seat of claim 1, wherein each of the first and second rotating arms comprises a first end that is rotatably mounted to the back support.

4. The swing seat of claim 3, wherein the back support comprises a lower portion and an upper portion and wherein the first end of each of the first and second rotating arms is rotatably mounted at a side of the upper portion.

5. The swing seat of claim 3, wherein the latch comprises first and second latch elements, the first latch element being positioned at a second end of the first rotating arm and the second latch element being positioned at a second end of the second rotating arm.

6. The swing seat of claim 5, wherein the second ends of the first and second arms are positioned directly in front of the back support when in the closed position and to the sides of the back support when in the open position.

7. The swing seat of claim 1, wherein rotation of each of the first and second arms from the closed position to the open position is controlled by one or more springs.

8. The swing seat of claim 1, wherein the latch comprises
a male element and a female element that operate as a buckle to secure the first and second rotating arms in the closed position, and
a button that, when pressed, releases the male element from the female element.

9. The swing seat of claim 8, wherein the male element extends from the second rotating arm and wherein a portion of the second rotating arm extends behind the male element to prevent pinching.

10. The swing seat of claim 1, wherein the rigid seat further includes one or more side restraints.

11. The swing seat of claim 10, wherein the rigid seat is an integral molded component.

12. The swing seat of claim 1, wherein a transition between the bottom support and the back support is rounded.

13. The swing seat of claim 1, further comprising a cushioning bumper attached to the bottom of the rigid seat.

14. The swing seat of claim 13, wherein the cushioning bumper extends across the entire side-to-side width of the rigid seat.

15. The swing seat of claim 1, wherein each of the plurality of mounting elements is exterior to the rigid seat.

16. The swing seat of claim 15, wherein at least two of the plurality of mounting elements are secured to the rigid seat by rods, and
wherein the rods also serve as axles for the first and second rotating arms.

17. The swing seat of claim 1, wherein each of the first and second rotating arms is rigid and wherein each of the first and second rotating arms is rotatably mounted to an axle that extends through a portion of the rigid seat.

18. The swing seat of claim 17, wherein each of the first and second rotating arms is curved downward so as to extend over a seat occupant's shoulders and down to a midsection of the seat occupant.

19. The swing seat of claim 1, further comprising a plurality of chains, each chain being affixed to at least one of the plurality of mounting elements and to an overhead support bar, such that the swing seat is suspended from the overhead support bar and operable to move in a to and fro swinging motion.

20. The swing seat of claim 19, wherein the plurality of chains comprises front chains and rear chains and wherein the first and second rotating arms do not extend forward of the front chains in either the open or closed position or when moving between the open and closed position.
